(19) United States
(12) Patent Application Publication
(10) Pub. No.: US 2005/0082127 A1
(43) Pub. Date: Apr. 21, 2005

(54) Passive vehicle suspension system with semi-active roll damping

(76) Inventors: Dennis Barber, Waukesha, WI (US); Bradley James Kramer, Boston, MA (US); Eric Norman Griesbach, North Prairie, WI (US)

Correspondence Address: QUARLES & BRADY LLP, 411 E. WISCONSIN AVENUE, SUITE 2040, MILWAUKEE, WI, 53202-4497, US

(21) Appl. No.: 10/689,387

(22) Filed: Oct. 20, 2003

(51) Int. Cl. F16F 9/34

(52) U.S. Cl. 188/266.2

(57) ABSTRACT

A suspension system has a pair of cylinders connected between the cab or axle and a chassis of a vehicle to isolate the driver from vibrations. A pair of hydraulic cylinders is coupled to opposite sides of the cab or axle and to the vehicle chassis. A separate accumulator is coupled each hydraulic cylinder to act as a hydraulic spring that attenuates side to side motion. A leveling valve selectively control the flow of fluid to or from both hydraulic cylinders to level the cab or seat in response to load changes.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to suspension systems which isolate a component, such as an operator cab or chassis, from vibrations in other parts of a vehicle; and more particularly to hydraulic suspension systems in which the flow of fluid to and from a cylinder is controlled by an electrically operated valve.

2. Description of the Related Art

Vibration has an adverse affect on the productivity of work vehicles in which an operator cab is supported on a chassis. Such vehicles include agricultural tractors, construction equipment, and over the road trucks. The vibrations reduce the reliability of these vehicles, increase mechanical fatigue of components, and most importantly produce human fatigue due to motion of the operator's body. Therefore, it is desirable to minimize vibration of the vehicle cab or the operator's seat and of other vehicle components.

Previous vehicle cab suspension systems can be categorized as passive or active. Passive systems supported the cab with shock absorbers or resilient mounts, such as rubber blocks or airbags. In active suspension systems, the vehicle cab was supported by one or more hydraulic cylinder/piston assemblies with an electronic circuit sensing the vibration and responding by controlling flow of fluid to or from the hydraulic cylinder to produce motion that counteracted the vibration. Prior cab suspensions primarily addressed vertical movement related to pitch, front to back motion. However, with off-highway equipment, the predominant vibration that the operator feels relates to roll from side to side. Therefore, it is desirable for the vehicle cab suspensions to address both degrees of motion to improve the operator's comfort and increase equipment productivity.

In addition, the suspension system must be adjusted to accommodate varying loads in the cab. The combined mass of the cab varies significantly depending upon the size of the vehicle operator, a passenger who may be present and equipment that may be loaded onto the cab. A relatively large mass causes the cab to be lowered on the suspension system which could then bottom out during vibrations. Likewise a cab with a significantly small mass will raised by the suspension system to a point at which the system may top out during vibrations. Depending on the placement of the loads, one side of the cab may be lower than other sides. In order for the vibrations to be properly dampened, the suspension system has to center the cab between the extremes of travel when the vehicle stops moving. Thus mechanism for leveling the cab under varying mass conditions commonly is provided.

### SUMMARY OF THE INVENTION

A semi-active suspension system is provided to isolate a vehicle component, such as an operator cab or seat, from vibrations. A first cylinder and a second cylinder are connected between the vehicle component and the chassis of the vehicle. The first cylinder has a first piston that defines a first chamber and a second chamber in the first cylinder, and a second cylinder has a second piston that defines a third chamber and a fourth chamber in the second cylinder.

A first flow control device connects the first chamber of the first cylinder to a hydraulic circuit node to restrict flow of fluid there between. A second flow control device connects the third chamber of the second cylinder to the hydraulic circuit node to restrict flow of fluid there between. A first accumulator is coupled to one of the first chamber of the first cylinder and the hydraulic circuit node, and a second accumulator connected to one of the third chamber of the second cylinder and the hydraulic circuit node.

A leveling valve has a first position in which the hydraulic circuit node is coupled to a source of pressurized fluid, a second position in which the hydraulic circuit node is coupled to a tank, and a third position in which the hydraulic circuit node is disconnected from both the source of pressurized fluid and the tank.

In one embodiment of the semi-active suspension system, the first flow control device comprises a first orifice connected between the first accumulator and the hydraulic circuit node, and the second flow control device comprises a second orifice connected between the second accumulator and the hydraulic circuit node. In this embodiment, the accumulators are connected to the respective cylinder chamber.

In another embodiment of the semi-active suspension system, and the first flow control device comprises a first proportional control valve connected between the first chamber of the first cylinder and the first accumulator; and the second flow control device comprises a second proportional control valve connected between the third chamber of the second cylinder and the first accumulator. In this latter embodiment, the accumulators are connected to the hydraulic circuit node.

### BRIEF DESCRIPTION OF THE DRAWINGS

FIG. 1 is a rear view of an agricultural tractor incorporating a suspension system according to the present invention;

FIG. 2 is a partially cut-away side view of the agricultural tractor;

FIG. 3 is a diagram of a first hydraulic circuit for the suspension system; and

FIG. 4 is a diagram of a second embodiment suspension system's hydraulic circuit with semi-active roll dampening.

### DETAILED DESCRIPTION OF THE INVENTION

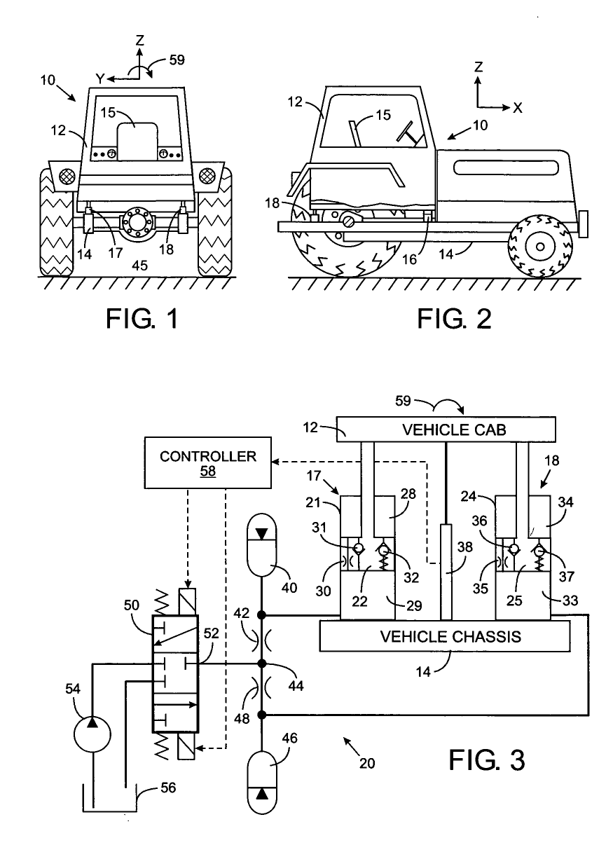

With reference to FIGS. 1 and 2, a vehicle 10, such as an agricultural tractor, has a cab 12 within which an operator sits on seat 15. The vehicle cab 12 is susceptible to motion in several degrees of freedom. Movement in a vertical direction Z is commonly referred to as “bounce”, whereas “roll” is rotation about the X axis of the vehicle 10, while rotation about the Y axis is referred to as “pitch.” To dampen this movement, the cab 12 is supported on the chassis 14 of the vehicle by a plurality of vibration isolators. For example, two hydromount vibration isolators are mounted on the chassis 14 adjacent the front comers of the cab with one hydromount 16 being visible in FIG. 2. Alternatively a single spherical mount with some degree of roll stiffness can be located at the front of the cab 12. In addition two vibration isolators 17 and 18 are located on the left and right sides of the chassis 14 beneath the rear portion of the cab 12. Although the suspension systems are being described in the context of damping vibrations of a cab of a vehicle, they could be employed as supports for dampening vibration of only the driver seat. Thus the cab and the seat are generically referred to herein as a driver support component of a vehicle.

Referring to FIG. 3, vibration isolator 17 for the suspension system 20 comprises a first cylinder 21 attached to the vehicle chassis 14 and having a first piston 22 with a rod connected to the vehicle cab 12. The other vibration isolator 18 is formed by a second cylinder 24 attached to the vehicle chassis and having a second piston 25 with a rod connected to the cab. A displacement sensor 38 is connected between the cab 12 and the chassis 14 and produces an electrical signal which indicates the relative displacement (Zrel) between the cab and the chassis. Although the present invention is being described in the context of a suspension system which supports the cab 12 of the vehicle 10, this system also could be employed to isolate only the operator seat 15 from the floor of the cab 12.

The first piston 22 defines a rod chamber 28 and a head chamber 29 in the first cylinder 21. A first damping orifice 30 extends through the first piston 22 between the piston and rod chambers 28 and 29. The first piston 22 also has a first internal check valve 31 which allows the free flow of fluid only in a direction from the head chamber 29 to the rod chamber 28. Flow in the opposite direction, from the rod chamber 28 into the head chamber 29, is permitted by a pressure relief valve 32 when the pressure in the rod chamber is a predetermined amount greater than that in the head chamber as determined by the spring of the pressure relief valve.

In a similar manner, the second piston 25 defines a rod chamber 33 and a head chamber 34 in the second cylinder 24. A second damping orifice 35 extends between these latter piston and rod chambers 33 and 34. The second piston 25 also has a second internal check valve 36 which allows the free flow of fluid only in a direction from the head chamber 33 to the rod chamber 34. Flow in the opposite direction is permitted by a pressure relief valve 37 when the pressure in the rod chamber 34 is a predetermined amount greater than that in the head chamber 33 as determined by the spring of the pressure relief valve.

Operation of the components 30-32 in the first piston 22 and the components 35-37 in the second piston 24 will be described more fully hereinafter. Alternatively, the damping orifices 32 and 35, check valves 34 and 36, and pressure relief valves 36 and 37 can be located outside the respective cylinder 21 or 24.

The head chamber 29 of the first cylinder 21 is directly connected to a first accumulator 40 and is coupled by a first orifice 42 to a hydraulic circuit node 44. Similarly, the head chamber 33 of the second cylinder 24 is directly connected to a second accumulator 46 and is directly connected a second orifice 48 to the node 44. The term “directly connected” refers to a connection of two or more hydraulic components by a conduit without any other intermediate element which restricts or controls the flow of fluid. The accumulators 40 and 46 act as hydraulic springs to attenuate high frequency vibrations. A three-position, closed-center leveling valve 50 that has a spool which is driven in opposite directions by a pair of solenoids. Depending upon which solenoid is energized, an outlet 52 of the leveling valve 50 is connected either to the outlet of a pump 54 or to a tank 56. When neither solenoid is energized, springs place the spool in a center, closed position in which the outlet 52 is disconnected from both the pump 54 and the tank 56.

The solenoids of the leveling valve 50 are activated by a controller 58 in response to the signal from the displacement sensor 38. The controller 58 is a conventional microcomputer based device and has a memory which stores a software program for execution by the microcomputer to operate the vehicle suspension system 20. The memory also stores data used and produced by execution of that software program. Input/output driver circuits are provided for interfacing the microcomputer to the displacement sensor 38 and to the leveling valve solenoids. Although a separate controller 58 is shown for the vehicle suspension system 20, it should be understood that its functionality may be incorporated into a controller which governs the operation of other systems on the vehicle.

The leveling valve 50 is employed to level the cab 12. As noted previously, The mass of the cab varies, due to the size and number of passengers and other objects being carried and as a result the vertical position of the cab with respect to the chassis will vary. It is preferable that the cab's stationary position be centered between the extremes of vertical travel allowed by the suspension system 20 so that optimal vibration damping can occur. In other words, if the stationary position due to the particular cab mass is significantly toward one extreme, the pistons 22 and 25 may strike the adjacent ends of the cylinders 21 and 24 when vibrations occur.

The displacement sensor 38 provides a signal that informs the controller 58 of the cab's vertical static position relative to the chassis 14. If that signal indicates that the cab is significantly lower than the center, or level, position, i.e. lower by at least a predefined distance, the controller 58 activates the solenoid of the leveling valve 50 to connect the output of the pump 54 to the hydraulic circuit node 44. This action applies pressurized fluid through each orifice 42 and 48 to the head chambers 30 of both cylinders 21 and 24. As the hydraulic fluid enters each cylinder 21 and 24, the respective pistons 22 and 25 are forced upward thereby raising the cab 12. Because the two orifices 42 and 48 are of equal size the same amount of fluid flows to each cylinder and thus both sides of the cab are raised equally. Fluid pressure is allowed to equalize between the rod and head chambers by flowing through orifices 30 and 35 and check valves 31 and 36. The controller 58 continues to monitor the signal from the displacement sensor 38 as the pistons move upward. When the cab reaches the center, or level, position, the controller 58 deactivates the leveling valve 50 which returns to the center closed state thereby terminating the application of pressurized fluid to the cylinders 21 and 24.

Similarly if the signal from the displacement sensor 38 indicates that the cab 12 is significantly higher than the center, or level, position, i.e. greater than a predefined distance above the chassis 14, the controller 58 activates the solenoid of the leveling valve 50 to connect the hydraulic circuit node 44 to the tank 56. This action drains fluid from the head chambers 29 and 33 of both cylinders 21 and 24 through the orifices 42 and 48. As the hydraulic fluid is exhausted, the respective pistons 22 and 25 move downward thereby lowering the rear of the cab 12 equally on both sides. Because the leveling process does not require rapid flow of fluid to or from the cylinders the fixed orifices do not significantly impede this function. The motion of the pistons decreases pressure in the cylinder rod chambers 28 and 34 such that the higher pressure fluid in the associated head chamber 29 or 33 flows through the respective check valve 31 or 36, thereby filling the expanding volume of the rod chambers. The controller 58 continues to monitor the signal from the displacement sensor 38 as the pistons move downward. When the cab 12 reaches the center, or level, position, the controller 58 deactivates the leveling valve 50 which returns to the center closed state, thereby terminating the draining of fluid from the cylinders 21 and 24. Because the two cylinders 21 and 24 operate in unison to level the cab 12, the suspension system 10 can be considered as a two-point suspension having common front and rear points of control for leveling the cab.

However, when load leveling is not active, the suspension system 20 functions differently in response to vibrations which produce roll forces, in which case the two cylinders 21 and 24 operate independently. With reference to FIGS. 1 and 3, assume that forces acting on the cab 12 tend to produce a clockwise roll about the X axis, as indicated by arrows 59. Thus, the right side of the cab 12 tends to move down, while the left side tends to move up. The resultant downward motion of the second piston 25 in the right side, second cylinder 24 increases the pressure in its head chamber 33 which forces fluid to flow from the head chamber through the check valve 36 into the rod chamber 34. This movement of the piston 25 is dampened by restriction of that fluid flow due to the size of the check valve opening and because the volume of the rod chamber 34 is less than that of the head chamber 33 due to presence of the piston rod. The excess fluid flows into the second accumulator 46 where that fluid is stored under pressure. The series connection of the first orifice 42 and second orifice 48 severely restricts flow of this fluid toward the now expanding head chamber 29 of the first cylinder 21, effectively isolating the cylinders 21 and 24 and their hydraulic sub-circuits from each other.

At the same time, the clockwise roll motion tends to move the first piston 22 upward in the left side, first cylinder 21 thereby increasing pressure in its rod chamber 28. This motion is dampened by the internal fixed orifice 30 which controls the rate of fluid flow from the rod chamber 28 to the head chamber 29. When the fluid pressure exceeds a preset threshold, the pressure relief valve 32 opens to allow some of the fluid in the rod chamber 28 to flow into the head chamber 29. As the head chamber 29 is larger that the rod chamber 28, additional fluid required to fill the expanding head chamber is drawn from the first accumulator 40.

A counterclockwise roll motion about the X axis produces the opposite action of the two cylinder sub-circuits. That is pressure increases in the head chamber 29 of the first cylinder 21 and in the rod chamber of the second cylinder 24. However, the suspension system 20 functions in a like manner to dampen this motion.

A variation of the suspension system 20 employs single acting cylinders 21 and 24 in which case the rod chambers 28 and 34 are vented to the ambient atmosphere and the components 30-32 in the first piston 22 and the components 35-37 in the second piston 24 are eliminated.

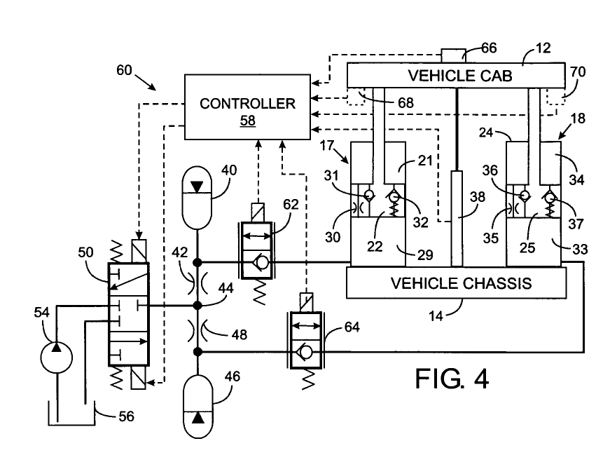

With reference to FIG. 4, a second suspension system 60 according to the present invention is similar to the first suspension system 20 with identical components being assigned identical reference numerals. However, the second suspension system 60 additionally includes a pair of electrohydraulic proportional control valves 62 and 64. The first control valve 62 is connected between the head chamber 29 of the first cylinder 21 and the first accumulator 40 and the second control valve 64 between the head chamber 33 of the second cylinder 24 and the second accumulator 46. For example, the first and second control valves 62 and 64 may be pilot-operated poppet type valves, such as the one described in U.S. Pat. No. 6,328,275. These control valves are normally biased by a spring into a closed position in which an internal check valve limits fluid flow to only a direction from the respective accumulator to the associated cylinder. The solenoid operators of the first and second control valves 62 and 64 are connected to outputs of the controller 58.

The second suspension system 60 further includes a gyroscope 66 that is physically mounted on the cab 12 to provide a signal which indicates the roll of the cab about the X axis. Instead of the gyroscope 66, a pair of accelerometers 68 and 70 can be mounted to the cab 12 adjacent the cylinders 21 and 24 to sense vertical acceleration and thus provide signals that indicate rolling motion of the cab. Velocity sensors could be used in place of the accelerometers. The signals produced by these motion sensors are applied to inputs of the controller 58.

The controller 58 responds to the input from the motion sensors 66, or 68 and 70 by operating the control valves 62 and 64 to dampen the roll of the cab 12. The controller 58 normally activates both control valves 62 and 64 in the fully open state, which provides passive damping of vertical motion along the Z axis, i.e. pitch of the cab front to back. However, when rolling movement of the cab 12 is detected, i.e. rotation of the cab about the X axis, the opening of one of the control valves 62 and 64 is reduced to restrict fluid flow and thus impede that rolling motion. For example, when the cab 12 is rolling clockwise, the controller 58 responds by reducing the degree to which the second control valve 64 is opened in proportion to the magnitude of the rolling motion being sensed. This impedes fluid flow from the head chamber 33 of the second cylinder 24 and thus the downward movement of the right side of the cab 12. The first control valve 62 remains fully open to allow fluid from the first accumulator 40 to flow into the expanding head chamber of the first cylinder 21. Likewise a counterclockwise roll results the first control valve 62 being partially closed to restrict fluid flow from the first cylinder 21 and the downward movement of the left side of the cab 12.

Thus the second suspension system 60 provides passive pitch control and semi-active roll damping.

Because the two control valves 62 and 64 can be closed as required to govern the flow of fluid, the two fixed orifices 42 and 48 may be eliminated with their function being taken over by the controller operating of the control valves to restrict fluid flow in the same manner.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A suspension system for damping vibration of a vehicle component which supports a driver of a vehicle wherein the vehicle component is supported by a chassis of the vehicle, said suspension system comprising:
a first cylinder and a second cylinder each connected between the vehicle component and the chassis and having a piston that defines a first chamber in the respective cylinder;
a first accumulator having a first port coupled to the first chamber of the first cylinder;
a second accumulator having a second port coupled to the first chamber of the second cylinder;
a hydraulic circuit node;
a first orifice connected between the first port of the first accumulator and the hydraulic circuit node;
a second orifice connected between the second port of the second accumulator and the hydraulic circuit node; and
a leveling valve connected to the hydraulic circuit node and having a first position in which the hydraulic circuit node is coupled to a source of pressurized fluid, a second position in which the hydraulic circuit node is coupled to a tank, and a third position in which the hydraulic circuit node is disconnected from both the source of pressurized fluid and the tank.

2. The suspension system as recited in claim 1 wherein the first cylinder has a second chamber on an opposite side of the piston from the first chamber of the first cylinder; and the suspension system further comprises:
a first check valve connected to the first cylinder and permitting fluid flow only in a direction from the first chamber to the second chamber of the first cylinder;
a first orifice connected between the first chamber and the second chamber of the first cylinder; and
a first relief valve connected in parallel with the first orifice, and opening when pressure in the second chamber is a predetermined amount greater than pressure in the first chamber.

3. The suspension system as recited in claim 2 wherein the first check valve, the first orifice and the first relief valve are integrated into the piston of the first cylinder.

4. The suspension system as recited in claim 2 wherein the second cylinder also has a second chamber on an opposite side of the piston from the first chamber of the second cylinder; and the suspension system further comprises:
a second check valve connected to the second cylinder and permitting fluid flow only in a direction from the first chamber to the second chamber of the second cylinder;
a second orifice connected between the first chamber and the second chamber of the second cylinder; and
a second relief valve connected in parallel with the second orifice, and opening when pressure in the second chamber is a predefined amount greater than pressure in the first chamber of the second cylinder.

5. The suspension system as recited in claim 4 wherein the second check valve, the second orifice and the second relief valve are integrated into the piston of the second cylinder.

6. The suspension system as recited in claim 1 further comprising a first proportional control valve coupling the first cylinder to the first accumulator.

7. The suspension system as recited in claim 6 further comprising a second proportional control valve coupling the second cylinder to the second accumulator.

8. The suspension system as recited in claim 7 further comprising:
a sensor for detecting rotational motion of the vehicle component about an axis and producing a signal indicating the rotational motion; and
a controller connected to the sensor and responding to the signal by controlling the first proportional control valve and the second proportional control valve to dampen the rotational motion.

9. The suspension system as recited in claim 8 wherein the controller is connected to the leveling valve and operates the leveling valve in response to an input signal.

10. The suspension system as recited in claim 9 further comprising another sensor which detects displacement of the cab with respect to the chassis and produces the input signal.

11. A suspension system for damping vibration of a vehicle component which supports a driver of a vehicle wherein the vehicle component is supported by a chassis of the vehicle, said suspension system comprising:
a support connected between the vehicle component and the chassis and permitting movement there between;
a first cylinder connected between the vehicle component and the chassis and spaced from the at least one support, the first cylinder having a first piston that defines a first chamber and a second chamber;
a second cylinder connected between the vehicle component and the chassis and spaced from the at least one support, the second cylinder having a second piston that defines a third chamber and a fourth chamber;
a first accumulator having a first port;
a second accumulator having a second port;
a first proportional control valve coupling the first chamber to the first port of the first accumulator;
a second proportional control valve coupling the third chamber to the second port of the second accumulator;
a hydraulic circuit node coupled to the first port of the first accumulator and to the second port of the second accumulator; and
a leveling valve connected to the hydraulic circuit node and having a first position in which the hydraulic circuit node is coupled to a source of pressurized fluid, a second position in which the hydraulic circuit node is coupled to a tank, and a third position in which the hydraulic circuit node is disconnected from both the source of pressurized fluid and the tank.

12. The suspension system as recited in claim 11 further comprising:
a first orifice connected between the first port of the first accumulator and the hydraulic circuit node; and
a second orifice connected between the second port of the second accumulator and the hydraulic circuit node.

13. The suspension system as recited in claim 11 further comprising:
a first check valve connected to the first cylinder and permitting fluid flow only in a direction from the first chamber to the second chamber;
a first orifice connected between the first chamber and the second chamber; and
a first relief valve connected in parallel with the first orifice, and opening when pressure in the second chamber is greater than pressure in the first chamber;
a second check valve connected to the second cylinder and permitting fluid flow only in a direction from the third chamber to the fourth chamber;
a second orifice connected between the third chamber and the fourth chamber; and
a second relief valve connected in parallel with the second orifice, and opening when pressure in the fourth chamber is greater than pressure in the third chamber.

14. The suspension system as recited in claim 13 wherein the first check valve, the first orifice and the first relief valve are integrated into the first piston of the first cylinder; and the second check valve, the second orifice and the second relief valve are integrated into the second piston of the second cylinder.

15. The suspension system as recited in claim 14 further comprising:
a sensor for detecting rotational velocity of the vehicle component and producing a signal indicating the rotational motion; and
a controller connected to the sensor and responding to the signal by controlling the first proportional control valve and the second proportional control valve to dampen the rotational motion.

16. The suspension system as recited in claim 15 further comprising another sensor which detects displacement of the cab with respect to the chassis and in response produces an displacement signal, and the controller operates the leveling valve in response to the displacement signal.

17. A suspension system for damping vibration of a vehicle component which supports a driver of a vehicle wherein the vehicle component is supported by a chassis of the vehicle, said suspension system comprising:
a first cylinder connected between the vehicle component and the chassis, and having a first piston that defines a first chamber and a second chamber;
a second cylinder connected between the vehicle component and the chassis and, having a second piston that defines a third chamber and a fourth chamber;
a hydraulic circuit node;
a first flow control device connecting the first chamber of the first cylinder to the hydraulic circuit node to restrict flow of fluid there between;
a second flow control device connecting the third chamber of the second cylinder to the hydraulic circuit node to restrict flow of fluid there between;
a first accumulator connected to one of the first chamber of the first cylinder and the hydraulic circuit node;
a second accumulator connected to one of the third chamber of the second cylinder and the hydraulic circuit node; and
a leveling valve having a first position in which the hydraulic circuit node is coupled to a source of pressurized fluid, a second position in which the hydraulic circuit node is coupled to a tank, and a third position in which the hydraulic circuit node is disconnected from both the source of pressurized fluid and the tank.

18. The suspension system as recited in claim 17 wherein:
the first flow control device comprises a first orifice connected between the first accumulator and the hydraulic circuit node; and
the second flow control device comprises a second orifice connected between the second accumulator and the hydraulic circuit node.

19. The suspension system as recited in claim 17 wherein:
the first flow control device comprises a first proportional control valve connected between the first chamber of the first cylinder and the first accumulator; and
the second flow control device comprises a second proportional control valve connected between the third chamber of the second cylinder and the first accumulator.

20. The suspension system as recited in claim 17 further comprising:
a first check valve connected to the first cylinder and permitting fluid flow only in a direction from the first chamber to the second chamber;
a first orifice connected between the first chamber and the second chamber; and
a first relief valve connected in parallel with the first orifice, and opening when pressure in the second chamber is a predetermined amount greater than pressure in the first chamber;
a second check valve connected to the second cylinder and permitting fluid flow only in a direction from the third chamber to the fourth chamber;
a second orifice connected between the third chamber and the fourth chamber; and
a second relief valve connected in parallel with the second orifice, and opening when pressure in the fourth chamber is a predefined amount greater than pressure in the third chamber.
